(19) United States
(12) Patent Application Publication
(10) Pub. No.: US 2017/0300941 A1
(43) Pub. Date: Oct. 19, 2017

(54) ACADEMIC RANKING SYSTEM AND METHOD

(71) Applicants: Quayshawn Spencer, Swarthmore, PA (US); Chatchai Luangmanee, San Francisco, CA (US)

(72) Inventors: Quayshawn Spencer, Swarthmore, PA (US); Chatchai Luangmanee, San Francisco, CA (US)

(21) Appl. No.: 15/098,294

(22) Filed: Apr. 13, 2016

(51) Int. Cl. G06Q 30/02; H04L 29/08

(52) U.S. Cl. CPC G06Q 30/0203; H04L 67/02

(57) ABSTRACT

An academic ranking system and method. Academic institutions offering the same academic discipline are ranked. Citation data is classified into marketable specialties. Rankings based on the classified citation data are generated. Institutional academic rankings are then determined based on the ranking of classified citation data.

### BACKGROUND OF THE INVENTION

The present invention relates generally to computer data processing systems and methods and more specifically to computer data processing systems and methods for processing and ranking academic programs of institutions of higher learning, universities and the like.

Academic ranking of graduate programs for universities and other institutions of higher learning can be invaluable in various situations. As an example, applicants or prospective students that wish to select a particular graduate program can use such academic rankings to evaluate the graduate program. As another example, faculty members may also employ academic rankings to evaluate the quality or standard of their own academic programs.

Various organizations that provide such academic rankings include U.S. News & World Report Best Graduate Schools as well as the National Research Council. Individual entities such as Brian Leiter's Law School Rankings may also provide academic rankings.

The process of academic ranking typically begins by conducting numerous surveys. In some cases, as many as 15,000 surveys, of academic faculty including college administrators, academics and other professionals are conducted. The organization begins by preparing specific survey questions, and scrutinizing survey question wording to avoid possible bias in the questions.

Once the survey questions are prepared, they are forwarded to academic faculties for response. Once received, each academic or faculty member can then respond to the survey questions. Here, a faculty member may respond to a survey question. Another faculty member may also respond to the same question with a different response. Nevertheless, after some of the survey responses are completed, they are forwarded to the organization which then uses them to prepare the academic rankings.

Another approach for determining academic rankings is to use bibiliometrics, such as the average number of citations or publications per faculty member. The ranking may be across different disciplines (e.g., ranking biology and philosophy to determine an institution's ranking). The ranking may also be across specialties within a single discipline (e.g., ranking logic and ethics within philosophy to obtain an institution's ranking).

Many institutions, however, typically have different citation patterns for each discipline or specialty. For example, biologists may have higher average citations per publication while philosophers have lower average citations per publication. Thus, an organization may use bibliometrics to then rank a first institution with fewer biologists for example, higher than an institution with a predominance of philosophers regardless of the citation patterns of the disciplines.

A prospective student that wishes to employ this ranking to determine which graduate school to attend might attend the first school with the higher citation ranking even though the second school with the predominant philosophers may actually have a higher research quality. The philosophy faculty is, however, ranked lower because it has fewer citations per publication.

Yet, another traditional approach for determining academic rankings is to use z-scores and standardize the number of publications, the number of citations of publication and funding received by a program by dividing by the number of faculty in the program.

It is within the aforementioned context that a need for the present invention has arisen. The foregoing background has been provided as context for the present invention and is not intended to highlight or indicate specific disadvantages of conventional systems to which the present invention is limited.

### BRIEF SUMMARY OF THE INVENTION

Various aspects of an academic ranking system and method can be found in exemplary embodiments of the present invention.

In one embodiment, the method of the present invention ranks academic institution programs or disciplines based on citation data of faculty members of the respective academic institutions. An example of a discipline might be philosophy. Another example of a discipline might be mathematics.

Citation data classified into each specialty of the academic discipline of each institution is used to generate an initial or first ranking by specialty, where such initial ranking is based on each academic program's citation impact in the respective specialty. Unlike conventional taxonomy schemes that utilize survey and other like data, an embodiment of the present invention utilizes only citation data because such data is highly indicative of faculty research quality.

Specifically, for each specialty, the method of the present invention uses citation data to list faculty members from the most cited to the least cited in that specialty. Then, each faculty member on each specialty list is assigned a rank equal to her z-score. Unlike conventional systems that utilize citation data from multiple specialties to rank faculty members, such as average number of citations for a faculty member, an embodiment of the present invention does not use citation data from more than one specialty to rank faculty members, thus standardizing the citation data used to rank faculty. Further, if different citation patterns occur across specialties or disciplines, the conventional approach of not standardizing citation data might yield inaccurate results.

In a further embodiment, the method of the present invention may also utilize whether a specialty is marketable. In this manner, specialties that are known to be non-marketable are disregarded in one embodiment.

An embodiment of the present invention further employs the first ranking of faculty members to generate a second set of rankings of academic institutions by specialty. The second set of rankings is done by generating a rank for each academic institution in each specialty using the first ranking of faculty members. An academic institution's rank in a specialty is a linear function of the arithmetic mean of its faculty members' ranks in that specialty. The final or third ranking is done by generating an arithmetic mean of all of the ranks across all specialties for each academic institution, assigning a new rank to each academic institution equal to its arithmetic mean of specialty ranks, and ranking the academic institutions from lowest to highest rank. In this manner, the algorithm of the present invention, in a simple and intuitive manner, translates raw publication and citation data into a useful ranking of faculty research quality for many users including prospective university students and faculty.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates an academic ranking system according to an exemplary embodiment of the present invention.

FIG. 2 illustrates the application server of FIG. 1 and its components thereof in accordance with an exemplary embodiment of the present invention.

FIG. 3-1 (page 1 of FIG. 3) illustrates an academic ranking method according to an exemplary embodiment of the present invention.

FIG. 3-2 (page 2 of FIG. 3) illustrates an academic ranking method according to an exemplary embodiment of the present invention.

FIG. 4 illustrates a “table of discipline” interface according to an exemplary embodiment of the present invention.

FIG. 5 shows a “table of universities” interface according to an exemplary embodiment of the present invention.

FIG. 6 illustrates a “table of faculty members” interface corresponding to the “table of universities” interface of FIG. 5 according to an exemplary embodiment of the present invention.

FIG. 7A illustrates a “publication” interface according to an exemplary embodiment of the present invention.

FIG. 7B illustrates a “publication” interface according to an exemplary embodiment of the present invention.

FIG. 8 illustrates a “philosophy specialty” interface according to an exemplary embodiment of the present invention.

FIG. 9 illustrates an “edit record” interface according to an exemplary embodiment of the present invention.

FIG. 10 illustrates a citation data table for philosophy faculty members in each marketable specialty based on the number of citations according to an exemplary embodiment of the present invention.

FIG. 11 shows a philosophy faculty ranking table according to an exemplary embodiment of the present invention

FIG. 12 shows an exemplary embodiment of an overall ranking of the philosophy discipline for six academic institutions.

FIG. 13 illustrates a “graduation dataset user” interface according to an exemplary embodiment of the present invention.

FIG. 14 shows a “graduation ranking” interface according to an exemplary embodiment of the present invention.

FIG. 15 illustrates a “job dataset” interface according to an exemplary embodiment of the present invention.

FIG. 16 shows a philosophy first job placement ranking interface according to an exemplary embodiment of the present invention.

FIG. 17 illustrates a philosophy tenure-track job placement ranking according to an exemplary embodiment of the present invention.

FIG. 18 illustrates an overall ranking interface for philosophy according to an exemplary embodiment of the present invention.

FIG. 19 illustrates a personal interface according to an exemplary embodiment of the present invention.

FIG. 20A shows a typical desktop computer.

FIG. 20B shows subcomponents of the computer of FIG. 20A.

### DETAILED DESCRIPTION OF THE INVENTION

Reference will now be made in detail to the embodiments of the present invention, examples of which are illustrated in the accompanying drawings. While the present invention will be described in conjunction with embodiments, it will be understood that they are not intended to limit the present invention to these embodiments. On the contrary, the present invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

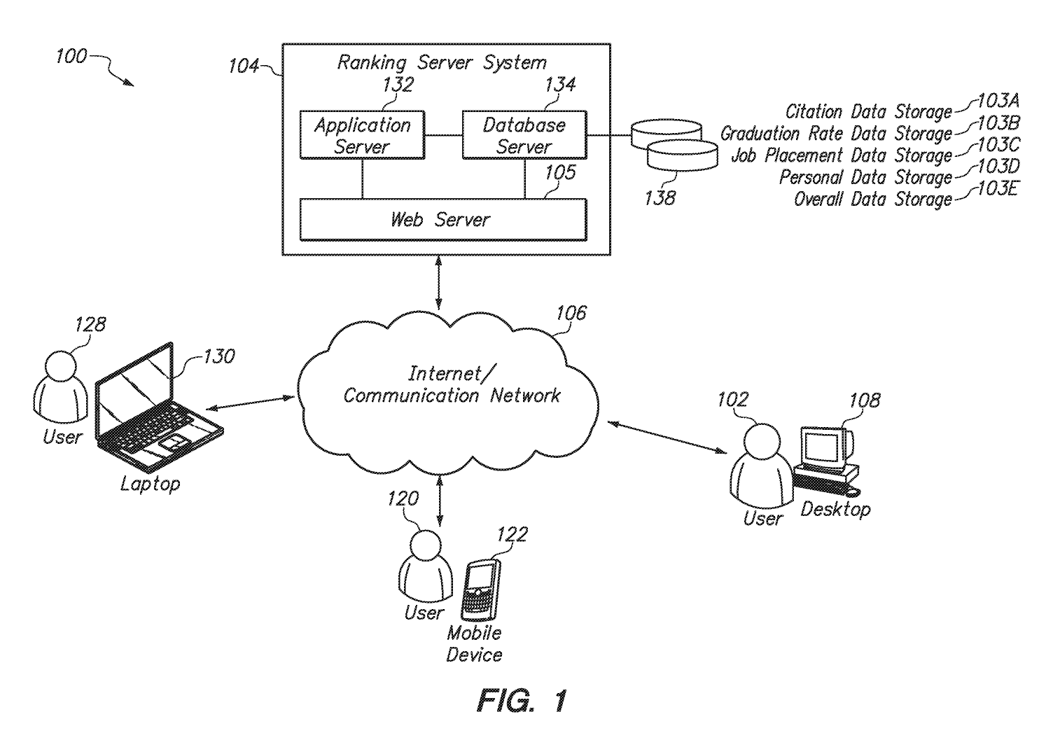

FIG. 1 illustrates academic ranking system 100 according to an exemplary embodiment of the present invention.

In FIG. 1, academic ranking system 100 comprises ranking server system 104 that is communicably coupled to a user 102 via Internet/communication network 106. Although not shown, Internet/communication network 106 represents any distributed network that may be wired, wireless or otherwise for data transmission and receipt between two points. The system of the present invention can work effectively with any possible distribution interconnected processors regardless of the specific topology, hardware and product protocols that are employed.

Here, user 102 might be an individual applicant or prospective student that is seeking to enroll in a graduate program of an academic institution. Specifically, user 102 can utilize desktop 108 to access ranking server system 104 via Internet/communication network 106 in order to gather relevant ranking information on various academic institutions that user 102 may wish to attend.

Ranking server system 104 includes web server 105 and application server 132. Web server 105 can be any combination of processors and/or software capable of communicating with user 102 via desktop 108. Specifically, web server 105 may host a website (not shown) via which user 102 can use desktop 108 to serve HTTP requests on web server 105.

Web server 105 responds to such HTTP requests and in conjunction with application server 132 and database server 134, both of which are communicably coupled to web server 105, might provide academic ranking information for graduate programs and the like of a plurality of academic institutions.

Similarly, database server 134 processes data for retrieval and storage on database storage 138, which might be a single storage system but is preferably individual storage databases that include citation data storage 103A, graduation rate data storage 103B, job placement data storage 103C, personal data storage 103D and overall data storage 103E.

Although any suitable web server, application server, database server and database system consistent with the principles and precepts of the present invention may be used, the present invention preferably uses Apache (web server), PHP programming language and MySQL database server on the server side.

In FIG. 1, academic ranking system 100 further includes user 120, also coupled to ranking server system 104 via Internet/communication network 106. Specifically, user 102 may use mobile device 122 to download an app from ranking server system 104 via which user 120 can communicate with ranking server system 104.

Here, user 120 may also be another individual or entity or the like such as a faculty member that is seeking to use ranking server system 104 to determine the quality of the program of an institution in which the faculty member is a member. Although not shown, user 120 may also use a desktop device for access to ranking server 104 via Internet/communication network 106.

In FIG. 1, academic ranking system 100 further includes user 128 also communicably coupled to ranking server system 104 via Internet/communication network 106. Here, user 128 might be another individual or entity that uses laptop 130 to access ranking server system 104 via Internet/communication network 106. Although not shown, user 128 may also utilize a mobile device, desktop or any comparable device to access ranking server system 104.

Briefly, in use, any one of users 102, user 120 and user 128 may access ranking server system 104, register and provide credentials for future access. User 102, for example, may employ a browser (not shown) to access ranking server system 104. Once access to ranking server system 104 is granted, user 102 can obtain ranking information for various universities, graduate programs and various academic institutions of higher learning as further discussed with reference to the following diagrams.

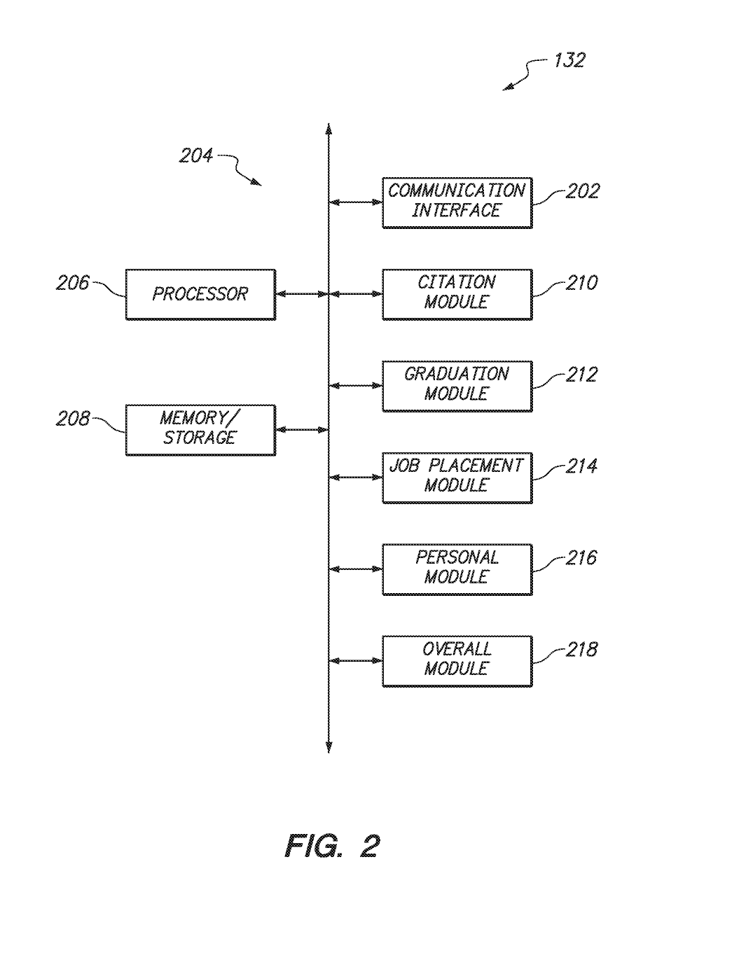

FIG. 2 illustrates application server 132 of FIG. 1 and its components thereof in accordance with an exemplary embodiment of the present invention.

In FIG. 2, processor 206, in conjunction with citation module 210, processes citation ranking code stored in memory/storage 208 to rank academic institutions based on citation data. The citation data represents the total number of citations to published works (journals, articles, books and the like) of faculty members.

Application server 132 also includes graduation module 212 as well as job placement module 214. Graduation module 212, in collaboration with processor 206, processes graduation ranking code that uses graduation rate data to rank universities and other institutions of higher learning.

In FIG. 2, job placement module 214 uses job placement rates of students that graduate from academic institutions to rank those institutions from the highest graduation rates to the lowest graduation rates. For example, an institution with a 98 percent graduation rate might receive a ranking of 1 while an institution with a 10 percent graduation rate might receive a ranking of 2.

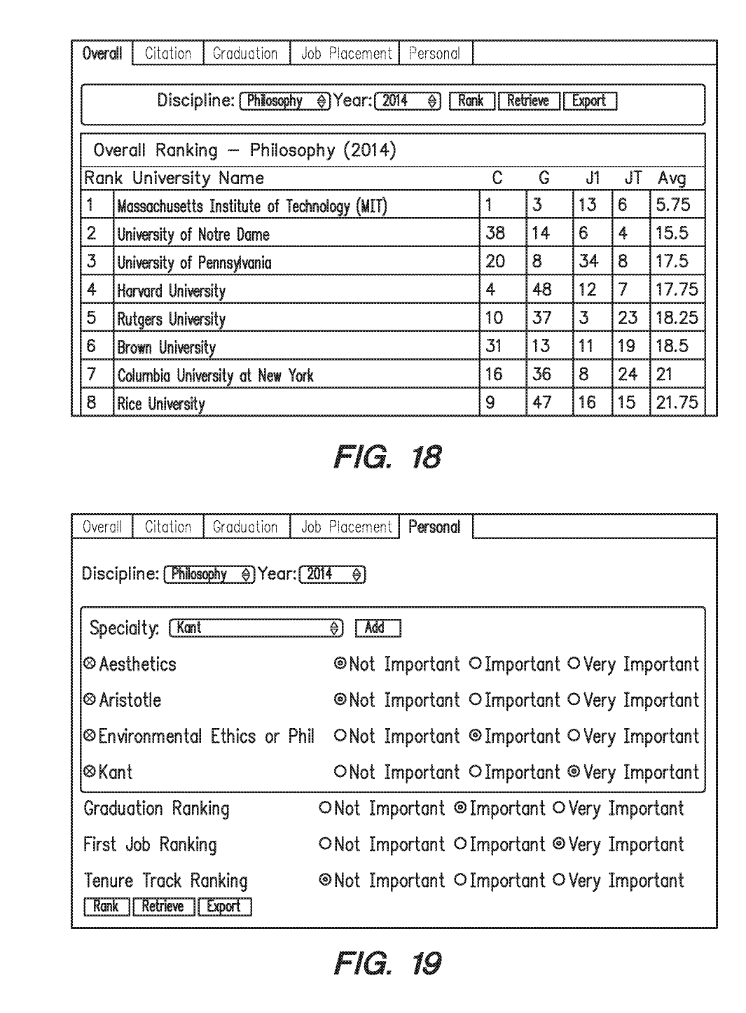

Application server 132 may also include communication interface 202 and overall module 218 that allows user 102 to use all applicable data in order to rank selected institutions. For example, user 102 may use citation, graduation and job placement data to rank institutions from highest to lowest as illustrated in FIG. 18.

Personal module 216, in conjunction with processor 206, enables the user 102 to weight and select from any one or more of applicable ranking data in accordance with the user's need to provide a ranking of various institutions. For example, user 102 may use personal module 216 to select citation data and job placement data but not graduation rate data and then rank a plurality of institutions based on the selected criteria. As another example, user 102 may choose to use graduation data only in which case graduation module 212 processes applicable code to produce a ranking of selected institutions based on graduation rate data alone.

Although not shown, one of ordinary skill in the art will realize that the components of application server 132 as shown and described are exemplary and that additional or fewer components may be used to achieve the principles and precepts of the present invention.

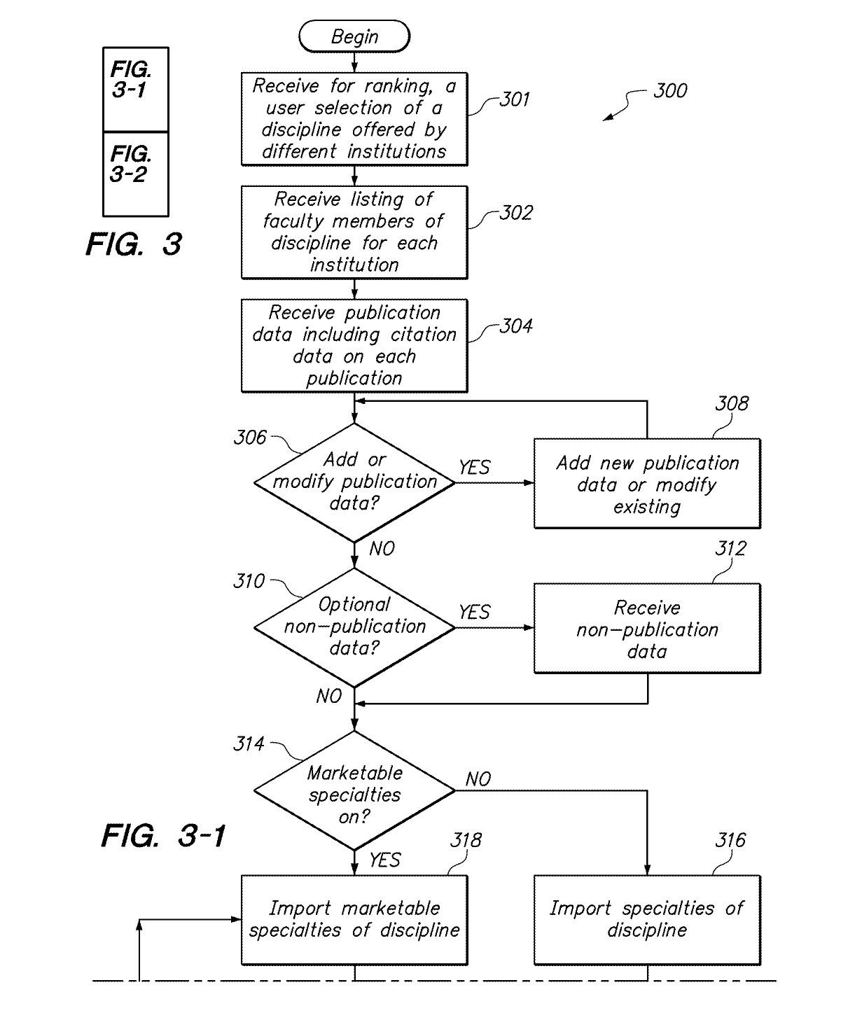

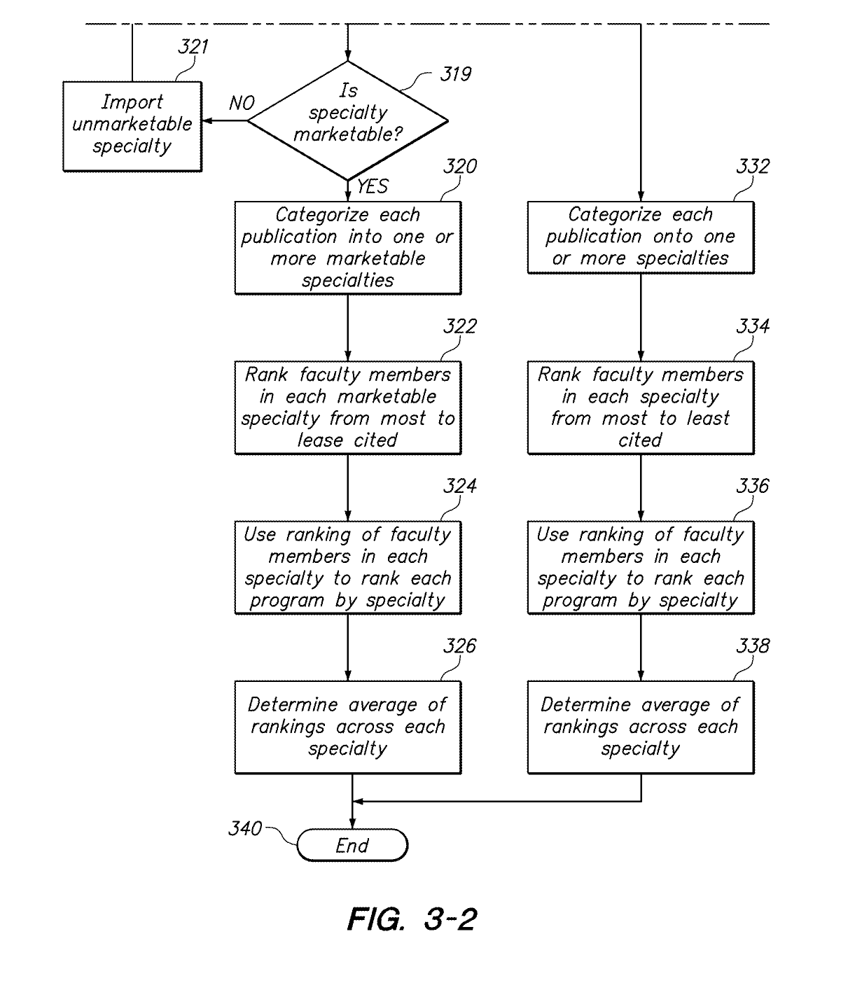

FIG. 3 (which includes FIG. 3-1 and FIG. 3-2) illustrates academic ranking method 300 according to an exemplary embodiment of the present invention.

In FIG. 3, user 102 (of FIG. 1) can utilize academic ranking method 300 to obtain rankings of various or a plurality of academic institutions based on citation, graduation and/or job placement data for example. Note here that academic ranking method 300 might be executed by academic ranking system 100 collectively or by either one or more of its components. For example, an act of receiving and processing published citation data might be implemented by ranking server system 104 even though the published citation data is selected and entered by user 102 via desktop 108.

At block 301, academic ranking system 100 receives for ranking user selections of a discipline offered by different institutions for ranking. Here, while no formal criteria exists for defining an academic discipline, a discipline may be a field of study or branch of knowledge that is taught and researched as part of a university faculty program to which an individual belongs.

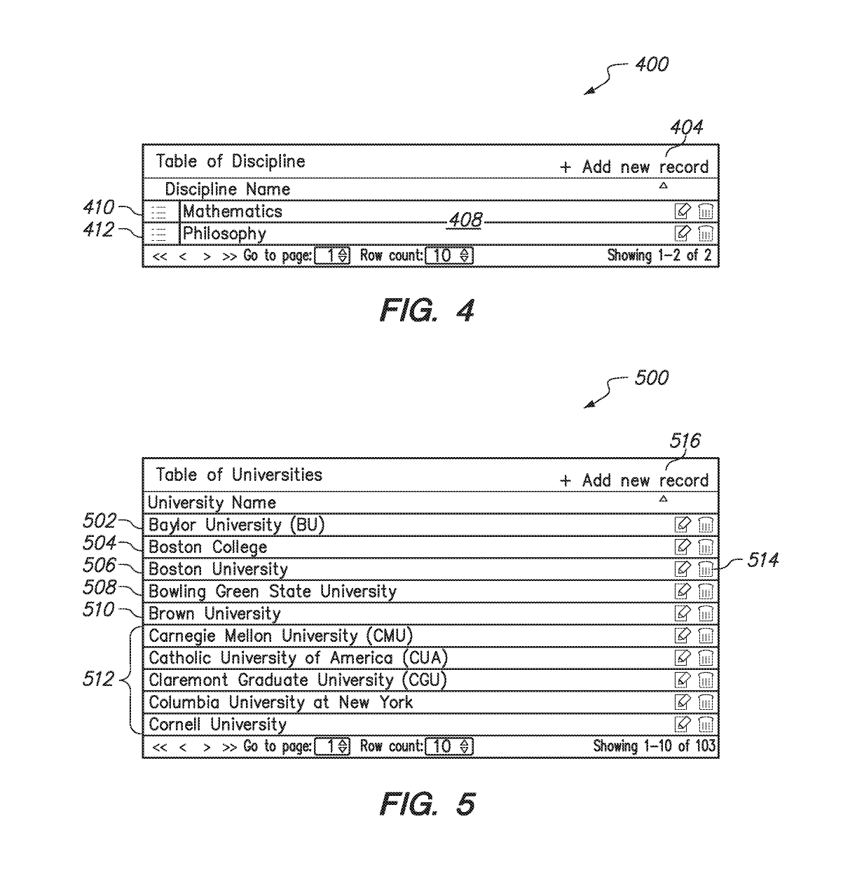

An example of a discipline might be mathematics. Another example of a discipline might be philosophy. The system of the present invention provides a user interface displayed within an app downloaded by user 102 or displayed within an applicable browser within a user's computer display interface. Once the user interface is displayed, user 102 can select a discipline and then rank many institutions that offer the selected discipline based on a number of criteria as illustrated in FIG. 4.

FIG. 4 illustrates “table of discipline” interface 400 according to an exemplary embodiment of the present invention.

In FIG. 4, “table of discipline” interface 400 receives and displays academic disciplines entered by user 102 for receipt by academic ranking system 100. User 102 can add a discipline by selecting “add new record” button 404.

Upon selection of “add new record” button 404, user 102 can then enter a discipline that is displayed within display area 408. As shown, here, user 102 has entered mathematics 410 as well as philosophy 412 for receipt by academic ranking system 100.

Referring to FIG. 3-1, at block 302, once a discipline offered by different institutions has been entered or selected, academic ranking method 300 involves receiving a listing of the institutions and associated faculty members for the discipline selected as illustrated in FIG. 5.

FIG. 5 shows a “table of universities” interface 500 according to an exemplary embodiment of the present invention.

As shown in FIG. 5, “table of universities” interface 500 includes Baylor University 502, Boston College 504, Boston University 506, Bowling Green State University 508, Brown University 510 as well as other universities 512. Preferably, the institutions ranked by academic ranking system 100 might be based on a predetermined data set previously entered by the system administrator.

The university data set may then be filtered or selected according to a user's desire. For example, user 102 may decide that Boston University need not be ranked in which case the user selects a “delete” button 514 to prevent Boston University 506 from being ranked. User 102 may also decide to add additional universities to the data set in which case user 102 may select the “add new record” button 516 to add a new university to the data set.

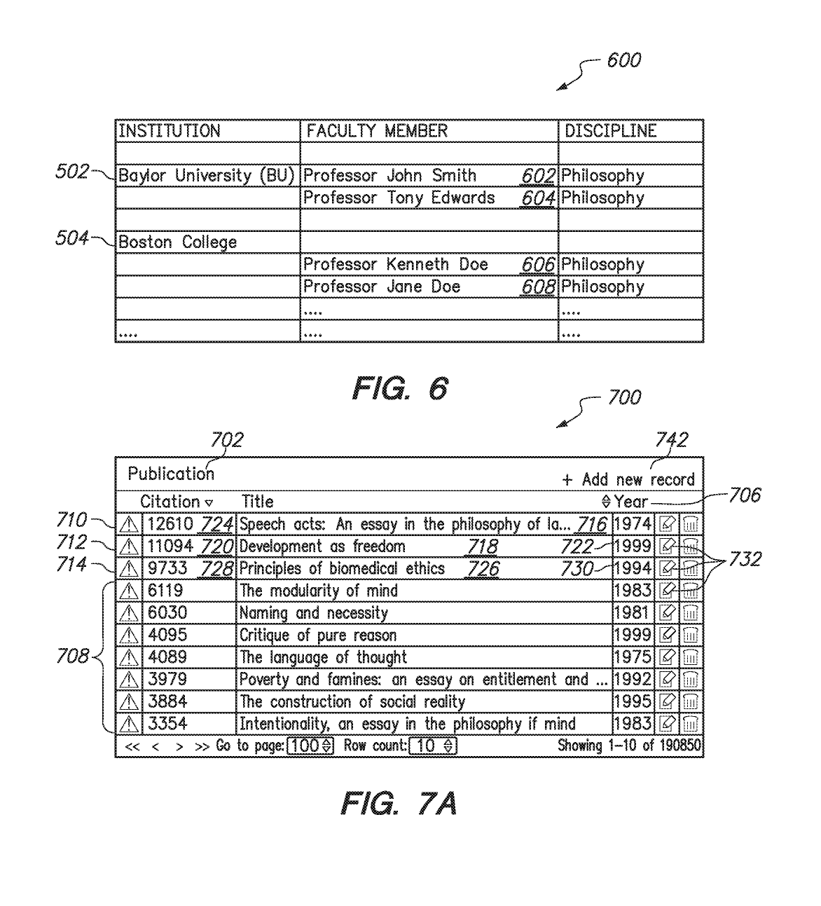

Note that the illustrated universities in this example are the universities that offer the selected discipline (e.g., philosophy 412 of FIG. 4) so that all of the universities that offer philosophy 412 are ranked to determine the research quality of their philosophy programs. In one implementation, if Brown University 510 receives a ranking of 1 for its philosophy program and Boston College 504 receives a ranking of 2 for its philosophy program, the indication is that the research quality at Brown University 510 is higher than that of Boston College 505. The corresponding table of faculty members for each academic institution is shown in FIG. 6.

FIG. 6 illustrates “table of faculty members” interface 600 corresponding to the “table of universities” interface 500 of FIG. 5 according to an exemplary embodiment of the present invention.

In FIG. 6, faculty members for the selected discipline for corresponding universities are shown. Specifically, for Baylor University 502, two professors, Professor John Smith 602 and Professor Tony Edwards 604, are faculty members of the Philosophy Department.

For Boston College 504, Professor Kenneth Doe 606 and Professor Jane Doe 608 are members of the selected discipline. User 102 may also add additional faculty members that the user is aware of and may delete faculty members as well if, for example, the user is aware that a particular faculty member is no longer with a school. After a listing of faculty members is generated, the process flows to block 304.

Referring now to FIG. 3, at block 304, academic ranking method 300 involves receiving publication data including published citation data on publications published by respective faculty members of the respective universities. In one embodiment, the present invention receives bibliometric data sets and, in particular, uses specialty-specific bibliometric data only to rank programs by faculty research quality.

Unlike surveys and the like that are subject to individual biases, the specialty-specific bibliometric data is not subject to such biases and is highly indicative of faculty research quality. Preferably, the citation data that is used by academic ranking system 100 is received as a dataset, which can then be modified, updated or deleted in accordance with a user's desire.

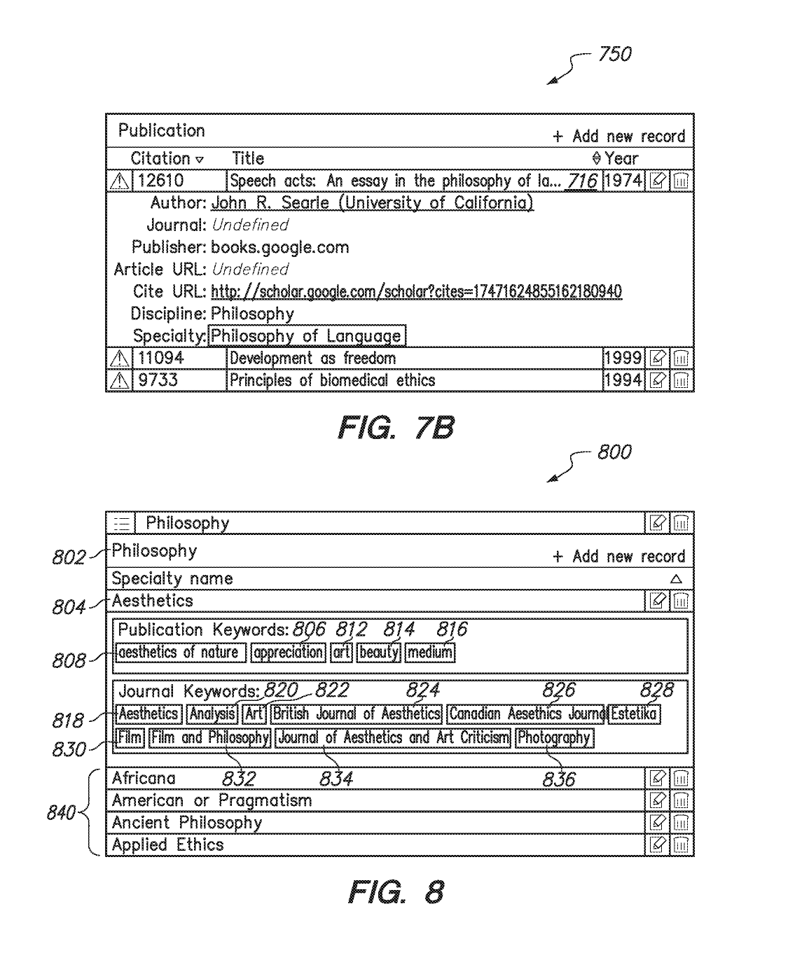

FIG. 7A illustrates “publication data interface 700 according to an exemplary embodiment of the present invention.

In FIG. 7A, user 102 may employ “publication data” interface 700 to display all citation data for each publication as well as add, delete and modify such citation data. As shown, publication data interface 700 includes various columns including citation 702, title 704 and year 706.

A plurality of rows of citation data 710, data 712, data 714 and data 708 is shown. Data 710 shows a publication “Speech Acts: An Essay in the Philosophy of Language” at 716, cited 12,610 times as shown at 724 and published in 1974 as shown at 721. Data 712, entitled “Development as Freedom” 718 has been cited 11,094 times as shown at 720 and was published in 1999 as shown at 722. Data 714 entitled “Principles of Biomedical Ethics” 726 has been cited 9,733 times as indicated at 728 and was published in 1994 as shown at 730.

User 102 can also use “publication data” interface 700 to add a new record by selecting “add new record” button 742. User 102 may also decide to delete records by selecting any one of a plurality of delete buttons 732.

Thus, referring now to FIG. 3, at block 306, it is decided whether user 102 wishes to modify the publication data. If yes, flow proceeds to block 308 where the user can add new data by using “add new record” button 742 or modify existing data by using edit button 732 or delete button 733. After publication data is either deleted or modified, flow proceeds back to decision block 306.

If the user does not wish to add or modify data, flow proceeds to decision block 310 where it is determined whether user 102 wishes to add optional non-publication data. Optional non-publication data includes “honors and awards received by faculty members” and other such non-publication type data.

If the user wishes to use non-publication type data, flow proceeds to block 312 where such non-publication type data is added. After the non-publication type data is added, flow proceeds to decision block 314.

Referring now to block 310, if the user simply wishes to use only publication citation data, flow skips block 310 and proceeds to decision block 314. Preferably, an embodiment of the present invention uses only publication data as such data is indicative of research quality of a faculty member.

At decision block 314, academic ranking method 300 determines whether marketable specialties have been turned on. A specialty is a sub-discipline of a discipline. In academia, it is common for disciplines to have specialties. An example of a specialty under philosophy is ethics. Another example of a philosophy specialty is logic. Yet another example is aesthetics.

An advantage of the present invention is that in one embodiment, only specialties that are marketable can be ranked. A specialty is marketable if it has met certain benchmarks that make it desirable for prospective students, educators and the like. In one embodiment, one benchmark for determining a marketable specialty is whether the specialty has produced at least five jobs for its graduates within the last five years. As another example, in another embodiment, a specialty might be marketable if it has produced tenure-track faculty members within a designated duration.

In FIG. 3, at decision block 314, an advantage of the present invention is that determining whether a specialty is marketable is optional. That is, user 102 can select whether the academic ranking system 100 determines if a specialty is marketable. For example, if user 102 wishes the system to assess whether the various specialties under philosophy are marketable, user 102 can select a button (not shown).

Thus, if the marketable specialty option is on, flow proceeds to block 318. If marketable specialties is not on, flow proceeds to block 316.

At block 318, academic ranking method 300 involves determining marketable specialties of the selected discipline. Here, the selected disciplines are either prepopulated from a data set or may be entered by user 102. Thus, user 102 can enter aesthetics under philosophy or may enter ancient philosophy or may enter American or pragmatism, all specialties of philosophy. Once all of the specialties have been identified, the system then determines whether those specialties are marketable based on benchmarks as previously discussed. Flow then proceeds to decision block 319.

At decision block 319, it is determined whether the specialty is marketable. If the specialty is marketable, flow proceeds to block 320. If a specialty is not marketable, flow proceeds to block 321.

At block 321, in one embodiment, the nonmarketable specialty is disregarded and the corresponding citation data for that specialty is lumped together with other marketable specialties. For example, if the clinical ethics specialty under philosophy is found to be nonmarketable and there are 25000 citation data points for that specialty, the specialty is disregarded, and the 25000 data points may then be added to a marketable specialty such as bioethics which itself has been found marketable.

Alternatively, in another embodiment, the nonmarketable specialty is completely disregarded, and the data corresponding to that nonmarketable specialty is thrown out and not lumped with marketable specialties. Process flow then returns to block 318 where it is determined whether the next specialty is marketable.

At block 320, academic ranking method 300 involves categorizing each publication into one of the more marketable specialties that were determined at block 318. In one embodiment, academic ranking system 100 uses publication keywords to categorize publications into respective specialties.

The publication keywords are then used for searching through publication titles in one embodiment. If a match exists between a publication keyword and a publication title, the publication is categorized into the marketable specialty corresponding to the publication keyword.

In another embodiment, the present invention uses journal keywords to categorize publications. Further yet, in another embodiment, the present invention uses both publication keywords and journal keywords to categorize publications into marketable specialties.

FIG. 7B illustrates “publication data” interface 750 according to an exemplary embodiment of the present invention.

In FIG. 7B, “publication data” interface 750 displays an expanded view of data 710 of FIG. 7A showing additional details including author and specialty of the published article.

FIG. 8 illustrates “philosophy specialty” interface 800 according to an exemplary embodiment of the present invention.

In FIG. 8, user 102 can use “philosophy specialty” interface 800 to display and add publication and journal keywords for a specialty. As shown here, under philosophy discipline 802 and aesthetics specialty 804, user 102 has added various publication keywords 806.

Specifically, user 102 has added aesthetics of nature 808, appreciation 810, art 812, beauty 814 and medium 816 as publication keywords under aesthetics. User 102 has also added aesthetics 818, analysis 820, art 822, the British Journal of Aesthetics 824, Canadian Aesthetics Journal 826, Estetika 828 and film 830. User 102 has also added film and philosophy 832, Journal of Aesthetics and Art Criticism 834, and photography 836 as journal keywords under the aesthetics specialty.

The system uses the selected keywords to search in one embodiment on the publication and journal titles to determine if a match exists. If a match exists, the selected publications are then classified under the specialty aesthetics 804 under philosophy 802. “Philosophy interface” 800 also shows various specialties 840 that have been added by user 102.

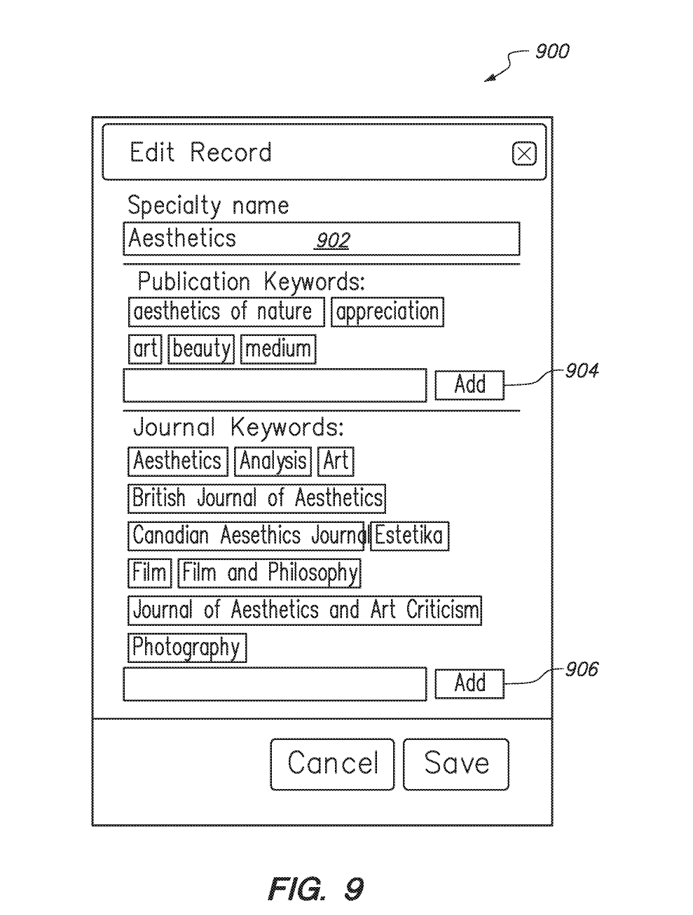

FIG. 9 illustrates keyword “edit record” interface 900 according to an exemplary embodiment of the present invention.

As shown in FIG. 9, user 102 may also edit specialty records by using “edit record” interface 900. Here, user 102 is editing the aesthetics record 902 and may use the add button 904 to add additional publication keywords or utilize add button 906 to add additional journal keywords.

Add button 904 is used to add additional publication keywords. Once all publications have been categorized into marketable specialties, process flow proceeds to block 322.

At block 322, academic ranking method 300 involves ranking faculty members in each marketable specialty from the most cited to the least cited faculty member.

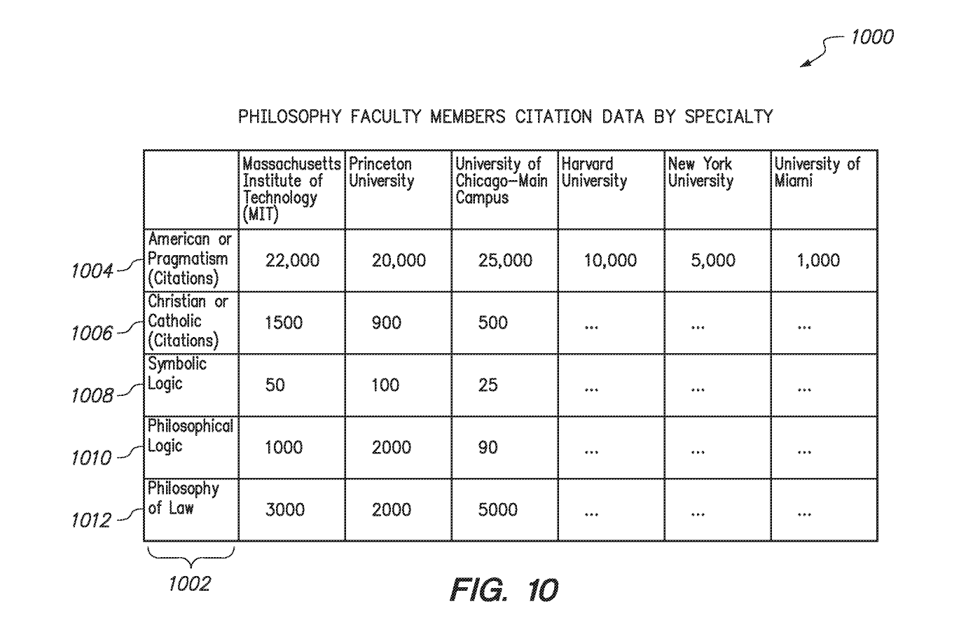

FIG. 10 illustrates table 1000 which illustrates total citation data of philosophy faculty members in each marketable specialty based on the number of citations according to an exemplary embodiment of the present invention.

Specifically, table 1000 shows philosophy faculty member citation data by specialty as well as philosophy disciplines in rows indicated by 1002.

In FIG. 10, row 1004 shows American or pragmatism. Row 1006 shows the specialty Christian or Catholic. Row 1008 shows the specialty symbolic logic. Row 1010 shows philosophical logic and row 1012 shows philosophy of law.

The column titles show the various institutions, namely, Massachusetts Institute of Technology, Princeton University, University of Chicago —Main Campus, Harvard University, New York University and University of Miami. As can be seen, each of the fields indicates citation data representing the cumulative number of times that publications by members of the philosophy faculty have been cited by others.

As an example, faculty members of Massachusetts Institute of Technology that teach American or pragmatism have been cited 22,000 times. Faculty members of Princeton University that publish in American or pragmatism have been cited 20,000 times; University of Chicago —Main Campus 25,000 times; Harvard University 10,000 times; New York University 5,000 times and University of Miami 1,000 times.

As another example, faculty members that teach Christian or Catholic 1006 at Massachusetts Institute of Technology have 1,500 citations and so forth. Note that data for Harvard University faculty members that teach Christian or Catholic 1006, symbolic logic 1008, philosophical logic 1010 and philosophy of law 1012 have been omitted.

Similarly, data for New York University and University of Miami faculty members teaching Christian or Catholic 1006, symbolic logic 1008, philosophical logic 1010 and philosophy of law 1012 have been omitted as not to unnecessarily complicate a description of the invention.

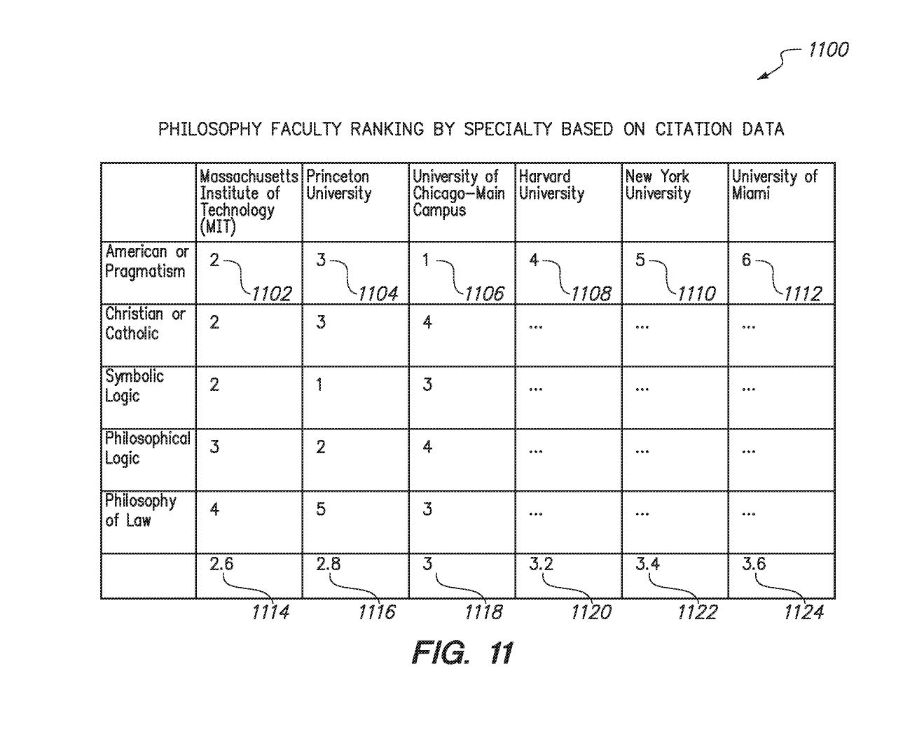

Referring to FIG. 3, academic ranking method 300 involves using the citation data for the faculty members to rank each program by specialty as illustrated in FIG. 11.

FIG. 11 shows philosophy faculty ranking table 1100 according to an exemplary embodiment of the present invention.

In FIG. 11, philosophy faculty ranking table 1100 shows faculty member rankings based on the citation data of FIG. 10.

As can be seen, the citation data for faculty members of Massachusetts Institute of Technology that research in American or pragmatism cited 22,000 times translate to a rank of 2, as shown at 1102. Similarly, the total citation of 20,000 for Princeton University faculty members that research in American or pragmatism is rank 3, as shown at 1104.

The 25,000 citations of University of Chicago —Main Campus faculty members for American or pragmatism is a rank of 1 as shown at 1106. The 10,000 citations for Harvard University faculty members for American or pragmatism is a rank of 4 as shown at 1108.

New York University faculty member's 5,000 citations for American or pragmatism is a rank of 5, while the University of Miami's faculty members' American or pragmatism citation data yield a rank of 6, as shown at 1112. Therefore, University of Chicago—Main Campus ranks 1 because their American or pragmatism faculty members have the most citations (25,000) while the University of Miami faculty members that research in American or pragmatism have a rank of 6 because 1000 is the lowest cited number.

Similar rankings are also performed for the Christian or Catholic specialty, symbolic logic specialty, philosophical logic specialty and philosophy of law. Once the citation data is converted to rankings, the process proceeds to block 324. After the ranking of faculty members in each specialty is used to rank each program by specialty, flow proceeds to block 326.

At block 326, academic ranking method 300 determines the arithmetic average of rankings across each specialty. As shown in FIG. 11, Massachusetts Institute of Technology has an average ranking of 2.6 as shown at 1114.

Princeton University has a ranking of 2.8 as shown at 1116. University of Chicago—Main Campus has an average of 3 as shown at 1118. Harvard University has an average of 3.2 as shown at 1120. New York University has an average of 3.4 as shown at 1122 while University of Miami has an average of 3.6 as shown at 1124.

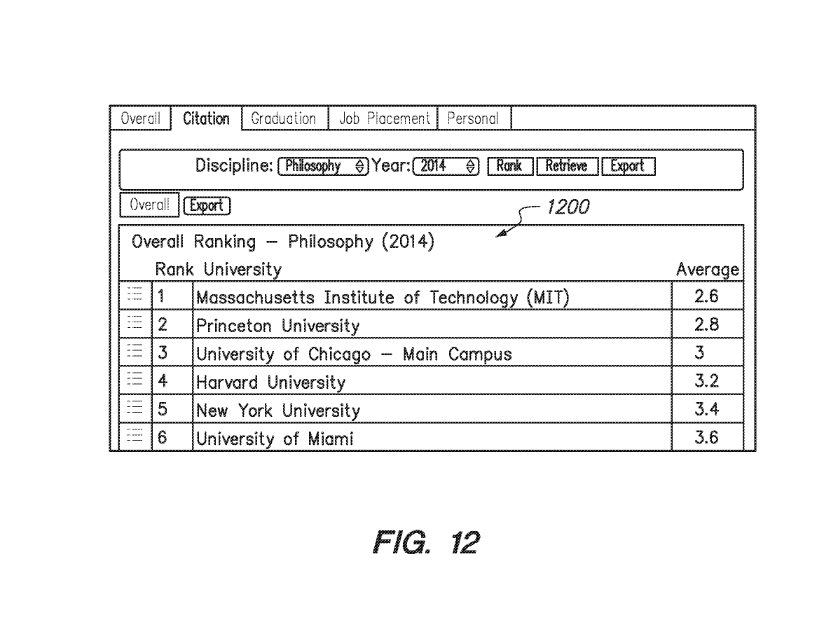

Accordingly, FIG. 12 shows an exemplary embodiment of an overall ranking of the philosophy discipline for all six academic institutions. As shown, Massachusetts Institute of Technology ranks 1 with an average rank of 2.6 while University of Miami ranks 6th with an average rank of 3.6. Referring now to decision block 314, if the marketable specialties selection/button/flag is off, flow proceeds to block 316.

At block 316, corresponding specialties for the discipline are determined. Unlike block 318, where the specialties are determined to be marketable, here it is irrelevant whether or not the specialties are marketable. Once the specialties are created by the user or prepopulated, they are used to rank the respective institutions.

At block 332, each faculty publication data is categorized into one or more specialties; at block 334 faculty members in each specialty are ranked from most cited to least cited; at block 336 ranking of faculty members in each specialty is used to rank each program by specialty, and at block 338, the arithmetic average of rankings across all specialties is determined. Flow there proceeds to end block 340

Graduation Ranking

Algorithm: P3R Method for Ranking Graduation Rates

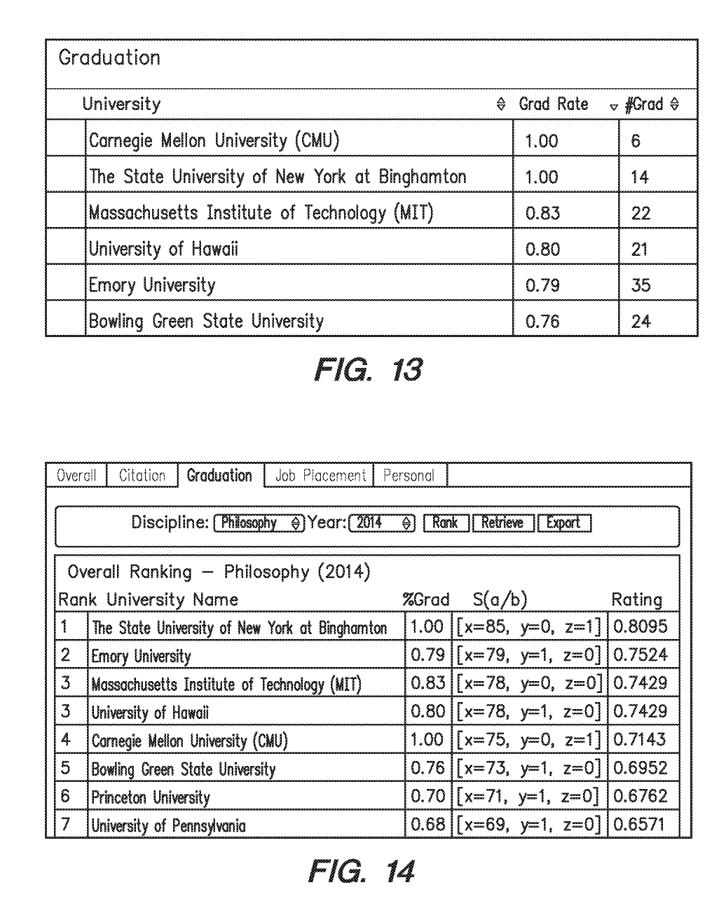

FIG. 13 illustrates a “graduation dataset user” interface 1300 according to an exemplary embodiment of the present invention.

(1) User 102 of FIG. 1 may begin with the first Grad Rate (RG) value in the RG column of FIG. 13. Suppose it's a/b. Assess whether a/b is GREATER THAN, LESS THAN, or EQUAL TO every other value in the RG column with a non-zero #Grad (NG) value associated with it (to the immediate right). Assume that subset of the RG column is ‘L’.

(2)-(4) below can then be used to decide whether a/b is GREATER THAN, LESS THAN, or EQUAL TO every other value on L. Note that a=NG and b=(NG/RG). It is preferable to round down to the nearest whole number to avoid introduction of bias.

The results for each RG value as a standing, S(RG), based on comparing it to every other value in L, is collected. Any RG value ‘a/b’ has a standing ‘S(a/b)’ equal to the ordered set ‘<x, y, z>’; where x=number of L items that a/b is GREATER THAN, y=number of L items that a/b is EQUAL TO, & z=number of L-items that a/b is LESS THAN.

Next, generate a rating, R(a/b), for each RG value ‘a/b’ using S(a/b). Namely, R(a/b)=(x)/(number of elements in L minus 1). Rank all schools according to their unique rating starting from #1 (highest rating) to #n (lowest rating among all L items).

Next, the RG value (in decimals) and standing is stated next to each school, but not its NG value. Also, a mouse scroll over x, y, & z for each standing brings up the names of the schools that generated each x, y, & z value.

(2) a/b is GREATER THAN c/d IFF a/b>c/d, binom.test(a,b,c/d,alternative=“greater”, conf.level=0.95) yields p-value≦0.05, AND binom.test(c,d,a/b,alternative=“less”, conf.level=0.95) yields p-value≦0.05.

(3) a/b is LESS THAN c/d IFF a/b<c/d, binom.test(a,b,c/d,alternative=“less”, conf.level=0.95) yields p-value≦0.05, AND binom.test(c,d,a/b,alternative=“greater”, conf.level=0.95) yields p-value≦0.05.

(4) a/b is EQUAL TO c/d IFF a/b is NOT GREATER THAN c/d OR a/b is NOT LESS THAN c/d. Note 1: The syntax in R for executing an exact binomial test is ‘binom.test(a,b,c/d,alternative=“greater”, conf.level=0.95)’ but can be shortened to ‘binom.test(a,b,c/d,“g”,0.95)’.

Algorithm: The P3R Method of Comparing Rates Using Raw Formula

1. Determining Significantly Higher Than

Suppose user 102 wishes to determine whether Northwestern has a significantly higher tenure-track (TT) placement rate than Cornell. Northwestern's TT placement rate, according to our dataset, is 8/21 (0.381), and Cornell's is 8/24 (0.333). Suppose Northwestern's rate is the observed TT-placement rate (R), and Cornell's the expected TT-placement rate (R_{E}).

So, the question is whether observing having 8 or more graduates with TT jobs in philosophy out of 21 graduates is significantly greater than an expected TT-placement rate of 8/24. Let the expected TT-placement rate (Cornell's) be ‘p’ and the observed TT-placement rate (Northwestern's) be ‘(j/n)’. In other words, ‘j’ is the number of observed TT-job getters and ‘n’ is the number of observed doctoral graduates.

$$\begin{matrix}Pr \{ {R}_{O} \geq \frac{i}{n} \vert {R}_{E} = p \} = {\sum }_{i = 0}^{i = n - j} ( \begin{matrix}n \\ j + i\end{matrix} ) {{p}^{j + i} ( 1 - p )}^{n - ( j + i )} & ( 1.1 ) \\ ( \begin{matrix}x \\ y\end{matrix} ) = \frac{x !}{y ! ( x - y ) !} \text{:} for any two natural numbers x \& y & ( 1.2 )\end{matrix}$$

In our case, j=8, n=21, and p=8/24. So, we would get the following series sum . . .

$$Pr \{ {R}_{O} \geq \frac{8}{21} \vert {R}_{E} = \frac{8}{24} \} = {\sum }_{i = 0}^{i = 21 - 8} ( \begin{matrix}21 \\ 8 + i\end{matrix} ) {( \frac{8}{24} )}^{8 + i} {( 1 - ( \frac{8}{24} ) )}^{21 - ( 8 + i )} = ( \begin{matrix}21 \\ 8\end{matrix} ) {( \frac{8}{24} )}^{8} {( 1 - ( \frac{8}{24} ) )}^{13} + ( \begin{matrix}21 \\ 9\end{matrix} ) {( \frac{8}{24} )}^{9} {( 1 - ( \frac{8}{24} ) )}^{12} + … + ( \begin{matrix}21 \\ 13\end{matrix} ) {( \frac{8}{24} )}^{13} {( 1 - ( \frac{8}{24} ) )}^{8} \approx 0.39923$$

Therefore the probability of “Northwestern's TT-placement rate being greater or equal to its observed value even though its expected value (Cornell's TT-placement rate) is 8/24” is approximately 0.399. This is the p-value since we will use a one-tailed test of significance.

We'll also assume a significance level of 0.05. In other words, it is assumed that the p-value is significant if and only if it is 0.05 or less. In our case, the p-value is insignificant.

Notice that (1.1) and (1.2) may be substituted yielding a p-value≦0.05 for “binom.test(a,b,c/d,alternative=“greater”, conf.level=0.95) yields p-value≦0.05” in our method of ranking if j=a, n=b, p=(c/d), and (j/n)>p. There's also no need to round ‘(c/d)’ down to the nearest whole number.

2. Determining Significantly Less Than

Using the same schools, and asking whether Cornell's TT-placement rate is significantly less than Northwestern's. This time assume Cornell's placement rate is Ro (a.k.a j/n) and that Northwestern's is R_{E} (a.k.a. p). Then the equation for determining whether observing eight or fewer successes out of 24 trials is significantly less than the expected value of 8/21 is the following:

$$Pr \{ {R}_{O} \leq \frac{j}{n} \vert {R}_{E} = p \} = {\sum }_{i = 0}^{i = j} ( \begin{matrix}n \\ j - i\end{matrix} ) {{p}^{j - i} ( 1 - p )}^{n - ( j - i )} \qquad ( 2.1 )$$

In our case, j=8, n=24, and p=8/21. So, we would get the following series sum . . .

$$Pr \{ {R}_{O} \leq \frac{8}{24} \vert {R}_{E} = \frac{8}{21} \} = {\sum }_{i = 0}^{i = 8} ( \begin{matrix}24 \\ 8 - i\end{matrix} ) {( \frac{8}{21} )}^{8 - i} {( 1 - ( \frac{8}{21} ) )}^{24 - ( 8 - i )} = ( \begin{matrix}24 \\ 8\end{matrix} ) {( \frac{8}{21} )}^{8} {( 1 - ( \frac{8}{21} ) )}^{16} + ( \begin{matrix}24 \\ 7\end{matrix} ) {( \frac{8}{21} )}^{7} {( 1 - ( \frac{8}{21} ) )}^{17} {( 1 - ( \frac{8}{21} ) )}^{17} + … + ( \begin{matrix}24 \\ 0\end{matrix} ) {( \frac{8}{21} )}^{0} {( 1 - ( \frac{8}{21} ) )}^{24} \approx 0.39998$$

Thus the p-value is approximately 0.400. Again the p-value is insignificant. Notice that we can substitute (2.1) and (1.2) yielding a p-value≦0.05 for “binom.test(a,b,c/d,alternative=“less”, conf.level=0.95) yields p-value≦0.05” in our method of ranking if j=a, n=b, p=(c/d), and (j/n)<p.

Use Case

| # | P3 | RG | NG |
|---|---|---|---|
| 1 | CARNEGIE MELLON UNIVERSITY | 1.00 | 6 |
| 2 | STATE UNIVERSITY OF NEW YORK AT | 1.00 | 14 |
| | BINGHAMTON | | |
| 3 | MASSACHUSETTS INSTITUTE OF | 0.83 | 22 |
| | TECHNOLOGY | | |
| 4 | UNIVERSITY OF HAWAII AT MANOA | 0.80 | 21 |
| 5 | EMORY UNIVERSITY | 0.79 | 35 |
| 6 | BOWLING GREEN STATE UNIVERSITY | 0.76 | 24 |
| 7 | UNIVERSITY OF OKLAHOMA NORMAN | 0.71 | 11 |
| | CAMPUS | | |
| 8 | PRINCETON UNIVERSITY | 0.70 | 35 |
| 9 | UNIVERSITY OF PENNSYLVANIA | 0.68 | 28 |
| 10 | LOYOLA UNIVERSITY CHICAGO | 0.65 | 25 |

Step 1: Start with the first RG value in the RG column which is 1.00. Therefore a/b=1.00 as starting with Carnegie Mellon.

Step 2: Assess whether a/b is . . .

2.1 GREATER THAN every other value in RG column

2.2 LESS THAN every other value in RG column, or

2.3 EQUAL TO every other value: RG column.

Let that subset of RG column be ‘L’ and also use binom.test as below; ** Note that a=NG, b=(NG/RG), and a/b=RG; ** Note that c=NG of another school, d=(NG/RG) of another school and c/d=RG of another school. For example, if we are comparing Carnegie Mellon (a/b) and MIT (c/d), we will have: a=6; b=6/1=6 a/b=1.00; c=22; d=22/0.83=26.51=26 (not to introduce bias, always round down to the nearest whole number); c/d=0.83. The result below is the L of Carnegie Mellon which compares its RG to the rest. (Note that the data below are hypothetical).

| P3 | Result |
|---|---|
| STATE UNIVERSITY OF NEW YORK AT | EQUAL |
| BINGHAMTON | |
| MASSACHUSETTS INSTITUTE OF TECHNOLOGY | LESS |
| UNIVERSITY OF HAWAII AT MANOA | GREATER |
| EMORY UNIVERSITY | GREATER |
| BOWLING GREEN STATE | GREATER |
| UNIVERSITY OF OKLAHOMA NORMAN CAMPUS | LESS |
| PRINCETON UNIVERSITY | LESS |
| UNIVERSITY OF PENNSYLVANIA | LESS |
| LOYOLA UNIVERSITY CHICAGO | LESS |

Step 3: Collect the results for each RG value as a standing S(RG) based on comparing it to every other value in L. From the step 3, we have L for each school.

Step 4: Any RG value ‘a/b’ has a standing ‘S(a/b)’ equal to the ordered set ‘<x, y, z>’; where 4.1 x=number of L-items that a/b is greater than (>); 4.2 y=number of L-items that a/b is equal to; 4.3 z=number of L-items that a/b is less than (<). From the step 4, we have S(a/b) of Carnegie Mellon as <x=3, y=1, z=5>.

Step 5: Generate a rating R(a/b) for each RG value ‘a/b’ using S(a/b) 5.1 R(a/b)=(x from S(a/b)<x,y,z>)/(#L−1) Therefore, R(a/b) of Carnegie Mellon=3/(9-1)=0.375; 5.2 Rank all schools according its rating R(a/b) from step 5.1

Final Result: The result of this should form the table below (note that data is all hypothetical).

| Ranking | University | RG | S(a/b) |
|---|---|---|---|
| 1 | CARNEGIE MELLON UNIVERSITY | 1.00 | <x = 3, y = 1, |
| | | | z = 5> |
| 2 | STATE UNIVERSITY OF NEW | 1.00 | <x = 1, y = 1, |
| | YORK AT BINGHAMTON | | z = 7> |
| 3 | MASSACHUSETTS INSTITUTE | 0.83 | <x = 4, y = 1, |
| | OF TECHNOLOGY | | z = 5> |
| 4 | UNIVERSITY OF HAWAII AT | 0.80 | <x = 4, y = 2, |
| | | | z = 1> |
| 5 | EMORY UNIVERSITY | 0.79 | <x = 5, y = 2, |
| | | | z = 2> |
| 6 | BOWLING GREEN STATE | 0.76 | <x = 5, y = 1, |
| | UNIVERSITY | | z = 3> |
| 7 | UNIVERSITY OF OKLAHOMA | 0.71 | <x = 6, y = 1, |
| | NORMAN CAMPUS | | z = 2> |
| 8 | PRINCETON UNIVERSITY | 0.70 | <x = 7, y = 2, |
| | | | z = 1> |
| 9 | UNIVERSITY OF PENNSYLVANIA | 0.68 | <x = 8, y = 1, |
| | | | z = 1> |
| 10 | LOYOLA UNIVERSITY CHICAGO | 0.65 | <x = 8, y = 2, |
| | | | z = 0> |

FIG. 14 also shows “graduation ranking” interface 1300 according to an exemplary embodiment of the present invention.

Job Ranking

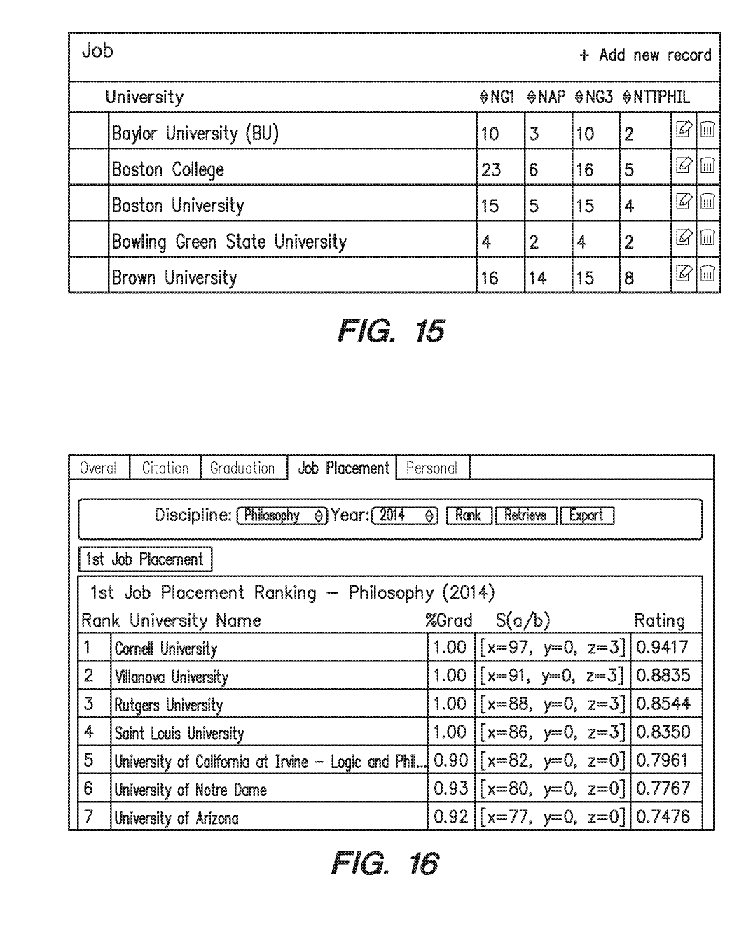

FIG. 15 illustrates a “job dataset” interface according to an exemplary embodiment of the present invention. In one embodiment, the job dataset may be imported via the import job menu.

Algorithm

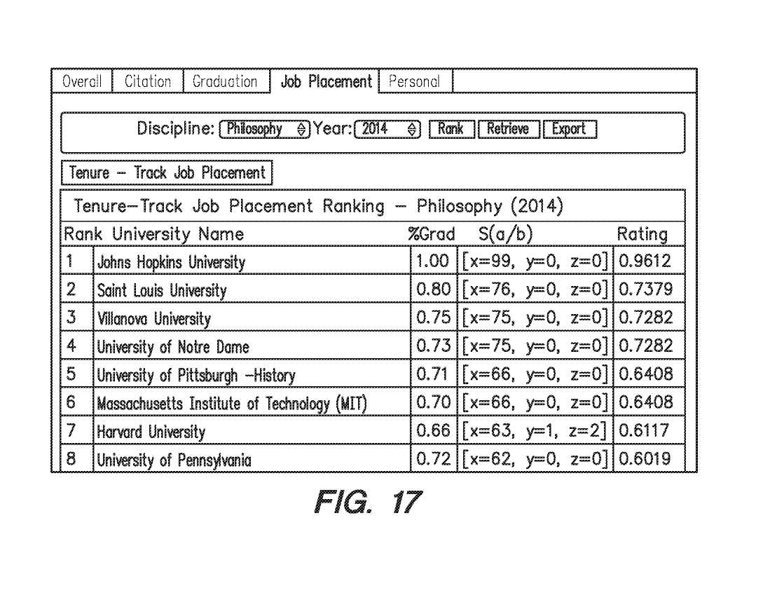

The algorithm that is used in job placement ranking is the same as that used in graduation ranking. The job placement ranking has two rankings, 1^{ST} job placement and tenure-track placement as illustrated in FIGS. 16 and 17.

Overall Ranking

The overall ranking is generated by using citation, graduation, and job placement rankings. The rankings are obtained by using the average of positions across rankings as illustrated in FIG. 18. In FIG. 18, MIT is in the top position as it has the highest average ranking of citation, graduation, 1st job placement and tenure-track job placement.

Personal Ranking

The personal ranking may use the same algorithm as the overall ranking, and in one embodiment, user 102 can specify the areas in which the user is interested. If the user is interested in citation ranking but only in some specialties, the user can add interested specialties with a desired weight as in FIG. 19.

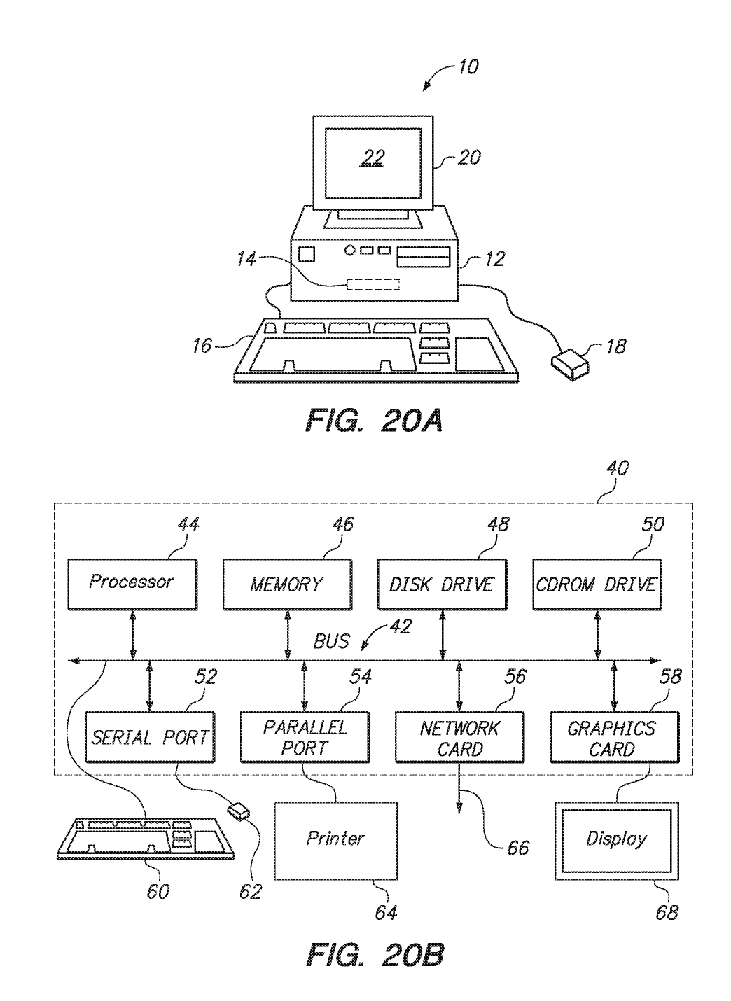

FIG. 20A shows a typical computer 10. Computer 10 includes a cabinet 12 housing familiar computer components such as a processor, memory, disk drive, Compact Digital Read Only Memory (CDROM), etc. (not shown). User input devices include keyboard 16 and mouse 18. Output devices include display 20 having a display screen 22. Naturally, many other configurations of a computer system are possible. Some computer systems may have additional components to those shown in FIG. 20A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 20A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 20A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 20B shows subsystems of the computer of FIG. 20A. In FIG. 5B, subsystems within box 40 are internal to, for example, the cabinet 12 of FIG. 20A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system and some of the subsystems shown in FIG. 20B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing system.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise. While the above is a complete description of exemplary specific embodiments of the invention, additional embodiments are also possible.

Thus, the above description should not be taken as limiting the scope of the invention, which is defined by the appended claims along with their full scope of equivalents.

I claim:

1. A method comprising:
by one or more processors associated with one or more computing devices establishing a network associated with at least one or more users and one or more servers, to rank a plurality of different academic institutions offering the same academic discipline;
by the one or more processors, determining which one of a plurality of specialties of the academic discipline of each academic institution in which to classify citation data that includes a cumulative number of times that a publication or journal by a faculty member of said academic institution has been cited;
by the one or more processors, determining for each specialty across all of the academic institutions, the most frequently cited faculty member and the least frequently cited faculty member based on the citation data;
by the one or more processors, using said citation data of most to least frequently cited faculty members to generate an initial or first ranking that ranks all of the faculty members by specialty across of the academic institutions; and
by the one or more of the processors, using the initial or first ranking of faculty members to generate a final or second ranking of the academic institutions, wherein said final or second ranking is by generating an arithmetic mean of all of the initial or first rankings across all of the specialties for each academic institution and ranking the arithmetic mean of each academic institution in order of magnitude.

2. The method of claim 1 further comprising by the one or more of the processor, determining whether each specialty of the academic discipline is marketable; wherein if a specialty is marketable classifying said citation data into the marketable specialty; and if a specialty is non-marketable, disregarding the non-marketable specialty by classifying none of the citation data within the non-marketable specialty.

3. The method of claim 2 wherein at least one criteria for determining whether each specialty of the academic discipline is marketable is by determining if said specialty has produced a graduate job within a previously determined designated duration of at least five years.

4. The method of claim 2 wherein at least one criteria for determining whether each specialty of the academic discipline is marketable is by determining whether the specialty has produced a tenure-track position within a previously determined designated duration of at least five years.

5. The method of claim 1 wherein said determining which one of a plurality of specialties of the academic discipline of each academic institution in which to classify citation data is by using a plurality of user-selected key words to search titles of publications by faculty members of the selected academic discipline.

6. The method of claim 1 wherein said determining which one of a plurality of specialties of the academic discipline of each academic institution in which to classify citation data is by using a plurality of key words to search titles of publications and journals that faculty members publish or publish in, in the selected academic discipline.

7. A computer program product including a computer readable storage medium and including computer executable code which when executed by a processor is adapted to:
rank a plurality of different academic institutions offering the same academic discipline;
determine which one of a plurality of specialties of the academic discipline of each academic institution in which to classify citation data that includes a cumulative number of times that a publication or journal by a faculty member of said academic institution has been cited;
determine for each specialty across all of the academic institutions, the most frequently cited faculty member and the least frequently cited faculty member based on the citation data;
use said citation data of most to least frequently cited faculty members to generate an initial or first ranking that ranks all of the faculty members by specialty across of the academic institutions; and
use the initial or first ranking of faculty members to generate a final or second ranking of the academic institution, wherein said final or second ranking is by generating an arithmetic mean of all of the initial or first rankings across all specialties for each academic institution and ranking the arithmetic mean of each academic institution in order of magnitude.

8. The computer program product of claim 7 including said computer executable code which when executed by a processor is further adapted to:
wherein if a specialty is determined to be marketable, classifying said citation data into the marketable specialty; and if a specialty is non-marketable, disregarding the non-marketable specialty by classifying none of the citation data within the non-marketable specialty.

9. The computer program product of claim 8 wherein at least one criteria for determining whether each specialty of the academic discipline is marketable is by determining if said specialty has produced a graduate job within a previously determined designated duration of at least five years.

10. The computer program product of claim 8 wherein at least one criteria for determining whether each specialty of the academic discipline is marketable is by determining whether the specialty has produced a tenure-track position within a previously determined designated duration of at least five years.

11. The computer program product of claim 7 wherein said determine which one of a plurality of specialties of the academic discipline of each academic institution in which to classify citation data is by use of a plurality of user-selected key words to search titles of publications by faculty members of the selected academic discipline.

12. The computer program product of claim 7 wherein said determine which one of a plurality of specialties of the academic discipline of each academic institution in which to classify citation data is by use of a plurality of key words to search abstracts of publications by faculty members of the selected academic discipline.
